(19) United States
(12) Patent Application Publication
(10) Pub. No.: US 2011/0062059 A1
(43) Pub. Date: Mar. 17, 2011

(54) DOCUMENT SORTING APPARATUS AND DOCUMENT SORTING METHOD

(75) Inventor: Daisuke Ishikawa, Shizuoka (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/844,057

(22) Filed: Jul. 27, 2010

Related U.S. Application Data
(60) Provisional application No. 61/243,000, filed on Sep. 16, 2009.

(51) Int. Cl. B07C 5/34; B07C 5/38

(52) U.S. Cl. 209/583; 209/629

(57) ABSTRACT

A document sorting apparatus according to an embodiment of the invention includes: two print detection units which are provided facing both sides of a sheet, respectively, and detect presence or absence of a print on each side and presence or absence of an indication of a confidentiality level; a confidential sheet housing unit which houses the sheet when a confidentiality indication level detected at least on one side is higher than a preset setting level; and a reuse sheet housing unit which houses the sheet when a print on the sheet is detected only by one of the two print detection units and there is no indication of the confidentiality indication level.

### CROSS-REFERENCE TO RELATED APPLICATION

This application is based upon and claims the benefit of priority from Provisional U.S. Applications 61/243,000 filed on Sep. 16, 2009, the entire contents of which are incorporated herein by reference.

### FIELD

An embodiment of the present invention relates to a document sorting apparatus and a document sorting method for reusing sheets that are printed on one side but are blank, that is, unused, on the other side.

### BACKGROUND

Recently, in view of effective use of resources, it is increasingly important to use sheets that are printed on one side but are blank on the other side in copiers or the like. Document sorting systems for this purpose are developed.

In order to reuse sheets that are printed on one side in this manner, it is convenient for reuse that sheets are stored in a cassette or the like with their unused sides facing upward or downward, that is, aligned on one side. A paper supply system in an image forming apparatus which stores sheets with their non-image formed sides (blank sides) facing upward, for example, is known.

However, all sheets that are used once are not necessarily printed on one side alone. Moreover, even sheets that are printed on one side may contain important matters. Thus, documents containing sheets that are used once generally include various kinds of sheets.

An embodiment of the invention is a document sorting apparatus and a document sorting method for sorting various documents including confidential documents and printed sheets, without waste and with security maintained. Another embodiment of the invention is a document sorting apparatus and a document sorting method that enable flexible setting of confidentiality levels where documents are treated as confidential.

### BRIEF DESCRIPTION OF THE DRAWINGS

FIG. 1 shows the structure of a document sorting apparatus according to a first embodiment of the invention.

FIG. 2 shows an exemplary configuration of a print detector according to the first embodiment.

FIG. 3 shows an exemplary configuration of a recognition comparison unit of the print detector shown in FIG. 2.

FIG. 4 shows a display position of a confidentiality level on a sheet and a detection range by the print detector.

FIG. 5 shows an exemplary electrical configuration according to the first embodiment.

FIG. 6 is a flowchart illustrating the operation according to the first embodiment.

FIG. 7 shows the structure of a second embodiment of the invention.

FIG. 8 shows an exemplary electrical configuration according to the second embodiment.

FIG. 9 shows the structure of a third embodiment of the invention.

FIG. 10 shows the relation between a fourth embodiment of the invention and an image forming apparatus.

### DETAILED DESCRIPTION

According to an embodiment of the invention, a document sorting apparatus includes: two print detection units which are provided facing both sides of a sheet, respectively, and detect presence or absence of a print on each side and presence or absence of an indication of a confidentiality level; a confidential sheet housing unit which houses the sheet when a confidentiality indication level detected at least on one side is higher than a preset setting level; and a reuse sheet housing unit which houses the sheet when a print on the sheet is detected only by one of the two print detection units and there is no indication of the confidentiality indication level.

Hereinafter, embodiments of the document sorting apparatus according to the invention will be described with reference to the drawings.

### First Embodiment

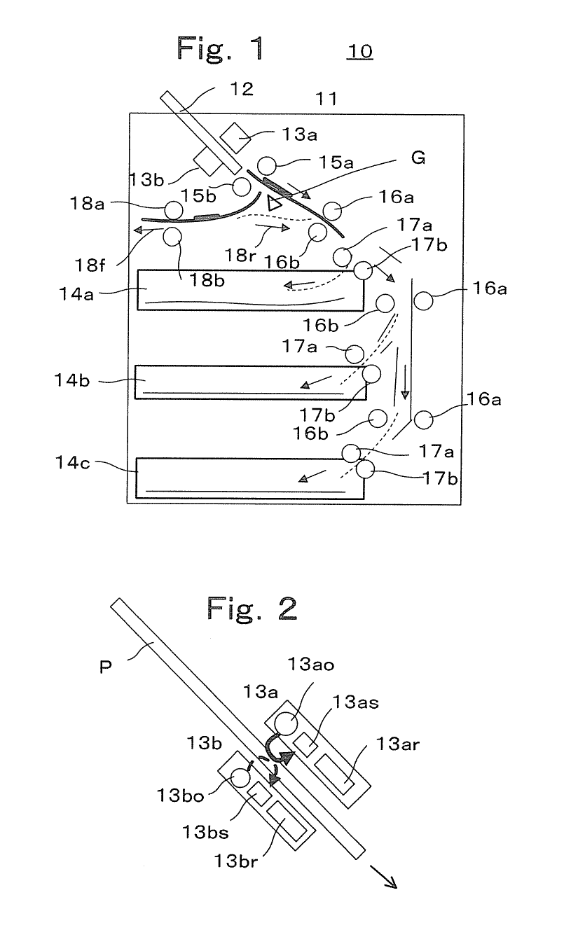

FIG. 1 shows the configuration of a document sorting apparatus according to a first embodiment of the invention. Roughly speaking, this document sorting apparatus 10 has an apparatus body 11, a sheet insertion tray 12, print detectors 13a and 13b which detect the presence or absence of a print on the face side and the back side of a sheet P, respectively, inserted from the sheet insertion tray 12, a reuse sheet cassette 14a which houses sheets printed on one side only, a disposal sheet cassette 14b which houses sheets printed on both sides, and a confidential sheet cassette 14c which houses sheets detected as confidential documents.

The sheets inserted in this document sorting apparatus 10 are classified into sheets having an indication that the sheets are confidential documents and sheets having no indication that the sheets are confidential documents. The sheets having no indication of confidential document include sheets printed on one side only and sheets printed on both sides. Sheets having no indication of confidentiality and printed on both sides are to be disposed of and housed in the disposal sheet cassette 14b.

Sheets having no indication of confidentiality and printed on one side only are housed in the reuse sheet cassette 14a with their unused sides aligned for reuse. On the sheets having the indication that the sheets are confidential documents, a confidentiality level of 1 to 5 is indicated. An indicated confidentiality (indication) level DL is compared with a preset setting level SL. If the confidentiality indication level DL is higher than the setting level SL, the sheet is housed in the confidential sheet cassette 14c.

The sheets hosed in the confidential sheet cassette 14c are also divided into two types, that is, sheets printed on one side only and sheets printed on both sides. The confidential sheets printed on one side only may be in two forms, that is, where the already printed sides (used sides) of the sheets face upward and where the used sides face downward. In this embodiment, it is assumed that when sheets are housed in the confidential sheet cassette 14c, the used sides of the sheets are not aligned.

The sheets printed on both sides may have an indication of a confidentiality level on both sides. If different confidentiality levels are indicated on the two sides, the higher confidentiality indication level is compared with the setting level. Moreover, there are cases where a confidentiality level is indicated on one side but no confidentiality level is indicated on the other side. In such cases, the indicated confidentiality level is compared with the setting level. If the indicated confidentiality level is determined as being higher than the setting level, this sheet is treated as a confidential sheet and is housed in the confidential sheet cassette 14c.

Although actually inserted sheets may include sheets that are not printed on either side, it is now assumed that sheets are always printed at least on one side.

The print detectors 13a and 13b are provided on the face side and the back side of the sheet insertion tray 12 and include, for example, light sources 13ao and 13bo which cast lights toward the sheet P, optical sensors 13as and 13bs which detect reflected lights from the sheet P of the lights cast from the light sources and have, for example, a linear shape, and recognition comparison units 13ar and 13br which recognize the reflected lights, as shown in FIG. 2.

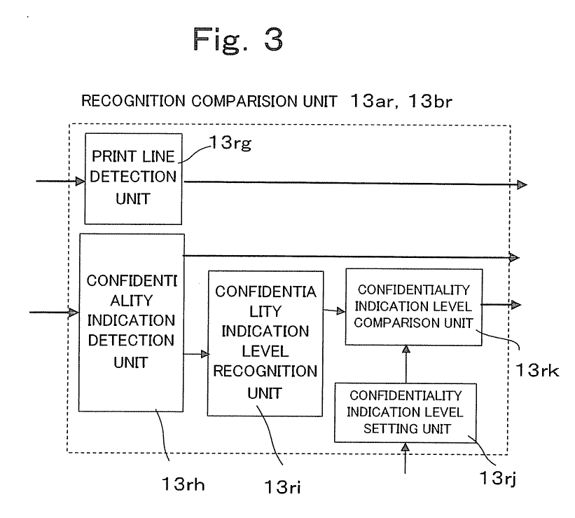

Each of the recognition comparison units 13ar and 13br has a print line detection unit 13rg, a confidentiality indication detection unit 13rh, a confidentiality indication level recognition unit 13ri, a confidentiality indication level setting unit 13rj, and a confidentiality indication level comparison unit 13rk, for example, as shown in FIG. 3.

The print line detection unit 13rg is a circuit to detect printed lines or the like. The confidentiality indication detection unit 13rh is a circuit to detect the presence or absence of a confidentiality indication. If a confidentiality indication is detected by the confidentiality indication detection unit 13rh, the confidentiality indication level recognition unit 13ri recognizes the confidentiality indication level. The recognized confidentiality indication level is sent from the confidentiality indication level recognition unit 13ri to the confidentiality indication level comparison unit 13rk.

Meanwhile, a preset confidentiality setting level is inputted to the confidentiality indication level comparison unit 13rk from the confidentiality indication level setting unit 13rj. This setting level may be set, for example, to 3 as an initial value and then may be changed by ten keys provided on the top panel of the apparatus body 11 of the document sorting apparatus 10.

It is also possible to change the confidentiality setting level every time a button is pressed. If the setting level for confidential documents can be changed or inputted from the top side of the apparatus body, there is an advantage that the range of documents that are treated as confidential documents can be changed easily and flexibly.

The confidentiality indication level comparison unit 13rk compares the confidentiality indication level inputted from the confidentiality indication level recognition unit 13ri with the setting level inputted from the confidentiality indication level setting unit 13rj, and sends a comparison result signal indicating whether the confidentiality indication level is higher than the setting level or not, to an overall control unit 24 (see FIG. 5) which will be described later.

Also a print presence or absence signal indicating whether the sheet is printed or not is sent to the overall control unit 24 from the print line detection unit 13rg. When no confidentiality indication is detected, a control signal indicating that no confidentiality indication is detected is sent to the overall control unit 24 from the confidentiality indication detection unit 13rh.

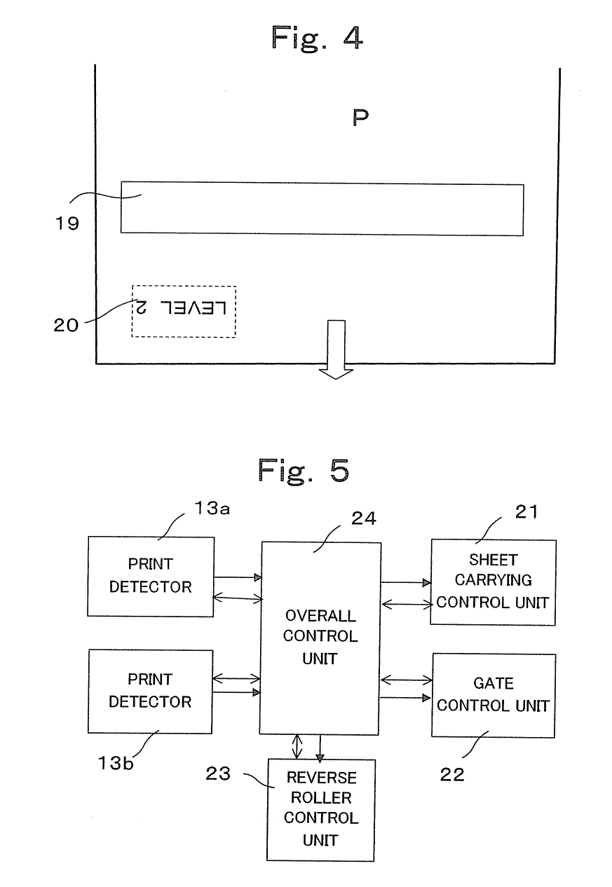

FIG. 4 shows the relation of the sheet P with the print detectors 13a and 13b. On the sheet P inserted upside down, an area 19 represents a range where the light source 13ao of the print detector 13a casts light and the optical sensor 13as receives reflected light. Therefore, if a certain description such as letters is detected within this range, the print detector 13a recognizes that this side is printed. An area 20 represents, for example, a range where a confidentiality class is indicated. As for the print detector 13b, the back side of the sheet P has areas at similar positions.

Each of the recognition comparison units 13ar and 13br has a built-in comparison circuit which recognizes an electrical signal acquired from the reflected light from the light sensor, then recognizes whether the corresponding side is printed and an indication of a confidentiality level of a confidential document, for example, a QR code, on the corresponding side, and compares the confidentiality indication level with a preset confidentiality level.

There are, for example, five confidential levels 1 to 5. Level 1 is the highest confidentiality level. Level 5 is the lowest confidentiality level. A sheet having no indication that the sheet is a confidential document is much lower in confidentiality. The indication that the sheet is a confidential document can be omitted if there is an indication of a confidential level.

Here, the indication that the sheet is a confidential document is omitted. The QR code is usually shown in the form of barcode. However, in FIG. 4, its content (level 2) is shown so that the content can be easily understood.

FIG. 5 shows an exemplary configuration of an electric control block in the document sorting apparatus 10 according to this embodiment. This document sorting apparatus 10 includes the print detector 13a which detects the presence or absence of a print on the face side of the sheet P, the print detector 13b which detects the presence or absence of a print on the back side of the sheet P, a sheet carrying control unit 21 which controls the rotation of each roller and thus controls the carrying and housing of the sheet P into each cassette, a gate control unit 22 which controls a gate G, a reverse roller control unit 23 which controls the rotation and the direction of rotation of reverse rollers 18a and 18b, and the overall control unit 24 which controls each of these units.

The overall control unit 24 receives information whether the face side and the back side of the sheet P are printed and whether there is an indication of a confidential class, from the recognition comparison units 13ar and 13br of the print detectors 13a and 13b.

In response to the result, the overall control unit 24 drives the sheet carrying control unit 21 and controls the rotation of carrying rollers 15a, 15b, 16a, 16b, housing rollers 17a, 17b, and the reverse rollers 18a, 18b. The following control is carried out by the overall control unit 24.

The sheet P inserted from the sheet insertion tray 12 is carried along a carrying path formed by the several pairs of carrying rollers 15a, 15b and 16a, 16b. The sheet P is then housed in the reuse sheet cassette 14a, the disposal sheet cassette 14b or the confidential sheet cassette 14c by the pair of housing rollers 17a, 17b in accordance with the type of the sheet to be housed. Which sheet cassette the sheet is housed in is decided in accordance with the circumstance where a print is detected by the print detectors 13a and 13b.

Moreover, the pair of reverse rollers 18a and 18b are provided near the carrying rollers 15a and 15b at the positions close to the sheet insertion tray 12, and a sheet reverse carrying path is thus formed. For example, it is now assumed that a sheet printed on the back side only is inserted in the sheet insertion tray 12. In this case, no print on the sheet is detected by the print detector 13a which detects a print on the face side of the sheet P, and a print is detected by the print detector 13b which detects a print on the back side of the sheet P.

The sheet P, inserted from the sheet insertion tray 12 and passed the first carrying rollers 15a and 15b, is carried once to the left in FIG. 1 by forward rotation of the pair of reverse rollers 18a and 18b as the gate G is controlled. After that, the sheet P is moved in a switchback-like manner by reverse rotation of the rollers 18a and 18b, then carried again and housed in the reuse sheet cassette 14a by the housing rollers 16a and 16b. The sheet P is housed in the reuse sheet cassette 14a with the printed side facing downward.

If the sheet P has an indication of a confidentiality level, and this confidentiality level is recognized as being higher than a predetermined confidentiality level, for example, level 3, the sheet P is housed in the confidential sheet cassette 14c.

If a print is detected on both sides by the print detectors 13a and 13b and no indication of confidentiality level is detected, the sheet P is housed in the disposal sheet cassette 14b. If a print is detected on one side by the print detector 13a or the print detector 13b and no indication of confidentiality level is detected, the sheet is housed in the reuse sheet cassette 14a with the printed side facing downward.

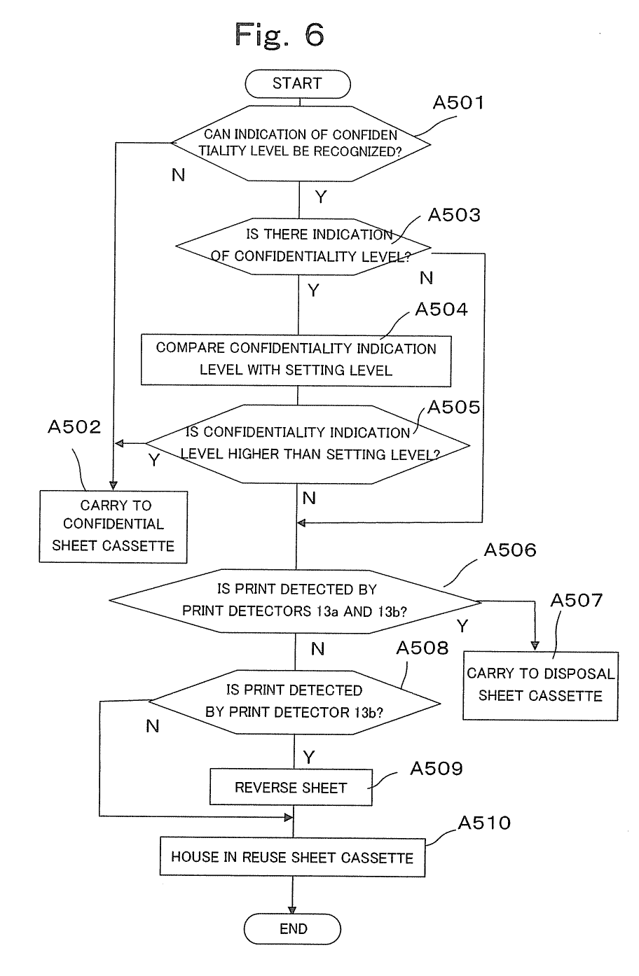

Next, the operation of the document sorting apparatus according to this embodiment will be described with reference to the flowchart shown in FIG. 6.

In ACT 501, it is first checked whether an indication of a confidentiality level can be recognized. In the print detectors 13a and 13b, lights from the internal light sources 13ao and 13bo are cast toward the sheet P and their reflected lights are received by the optical sensors 13as and 13bs. Each of the received lights is converted to an electrical signal. Depending on whether there is a fluctuation in the electrical signal, it is detected whether there is a print. The presence or absence of an indication of a confidentiality level is also recognized and the confidentiality indication level is recognized where this indication exists.

When this confidentiality indication is not recognized, the confidentiality level can be level 1 or 2 in the worst case scenario. Thus, if no indication of confidentiality level is recognized in FIG. 6 (N in ACT 501), the sheet is carried toward the confidential sheet cassette 14c and housed in this cassette in ACT 502.

On the other hand, when it is recognized that there is an indication of a confidentiality level, the processing shifts to ACT 503 and it is checked whether there is an indication of a confidentiality indication level. If the confidentiality indication level is recognized, the confidentiality indication level is compared with the setting level in ACT 504.

If the confidentiality indication level is higher than the setting level in the subsequent ACT 505 (Y in ACT 505), the processing shifts to ACT 502 and the sheet is carried toward the confidential sheet cassette 14c and housed in this cassette.

Meanwhile, if the confidentiality indication level is equal to or lower than the setting level in ACT 505 (N in ACT 505), the processing shifts to ACT 506. In ACT 506, the recognition comparison units 13ar and 13br examine whether a print is detected by the print detector 13a and the print detector 13b. In this case, the sheet is a confidential document but has a low confidentiality level and the sheet is printed on both sides. This sheet is sent to the disposal sheet cassette 14b.

If it is recognized that there is no indication of confidentiality level in ACT 503 (N in ACT 503), the processing similarly shifts to ACT 506 and it is examined whether a print is detected by the print detectors 13a and 13b, that is, whether the sheet is printed on both sides. If the sheet is printed on both sides (Y in ACT 506), the processing shifts to ACT 507 and the sheet is carried toward the disposal sheet cassette 14b and housed in this cassette.

On the other hand, if a print is not detected by the print detector 13a and the print detector 13b (N in ACT 506), it is checked whether a print is detected by the print detector 13b in ACT 508.

If a print is detected by the print detector 13b (Y in ACT 508), it means that the sheet P is printed on its back side only. Thus, in the subsequent ACT 509, the sheet P is reversed. That is, the overall control unit 24 sends a control signal to the gate control unit 22 and causes the gate G shown in FIG. 1 to operate in such a manner that the sheet P is carried to the reverse rollers 18a and 18b. Then, the sheet printed on the back side is carried to the left in FIG. 1 (the direction of an arrow 18f) by forward rotation of the reverse rollers 18a and 18b.

After a rear end of the sheet P is released from the carrying rollers 15a and 15b, the reverse rollers 18a and 18b are rotated backward and the sheet P is carried in the direction of an arrow 18r via the carrying rollers 16a and 16b. After that, the sheet P with its printed side facing downward is housed in the reuse sheet cassette 14a by the housing rollers 17a and 17b (ACT 510).

If no print is detected by the print detector 13b in ACT A508 (N in ACT 508), it is a case where a print is detected by the print detector 13a. In this case, the sheet P is printed on its face side. In this case, the sheet P is carried by the carrying rollers 16a and 16b from the carrying rollers 15a and 15b and housed in the reuse sheet cassette 14a by the housing rollers 17a and 17b. In this case, too, the printed side of the sheet P is the side facing downward.

In this manner, according to this embodiment, a confidential document having a confidentiality level exceeding the setting level is housed in the confidential sheet cassette 14c. A sheet that is printed on both sides and has no confidentiality indication and a sheet that is printed on both sides and has a low confidentiality level are housed in the disposal sheet cassette 14b.

A sheet that is printed on one side and has no confidentiality indication and a sheet that is printed on one side and has a low confidentiality level are housed in the reuse sheet cassette 14a with the printed side facing downward.

According to this embodiment, sheets are reversed by forward rotation and reverse rotation of the reverse rollers and unused sides of the sheets can be aligned to one side.

This embodiment has an advantage that even a sheet having a confidentiality indication can be reused if the confidentiality level is equal to or lower than a predetermined level, that is, the degree of confidentiality is low. Moreover, since the confidentiality setting level can be set from outside, there is an advantage that confidential documents that should not be reused and should be treated as confidential can be flexibly changed.

### Second Embodiment

In the first embodiment, if the printed side of a sheet printed on one side is its back side, the sheet is reversed by the reverse mechanism (switchback mechanism). However, the sheet can be reversed by another mechanism. In this second embodiment, sheets having a print detected on different sides are carried through different paths and the unused sides can be thus aligned to one side.

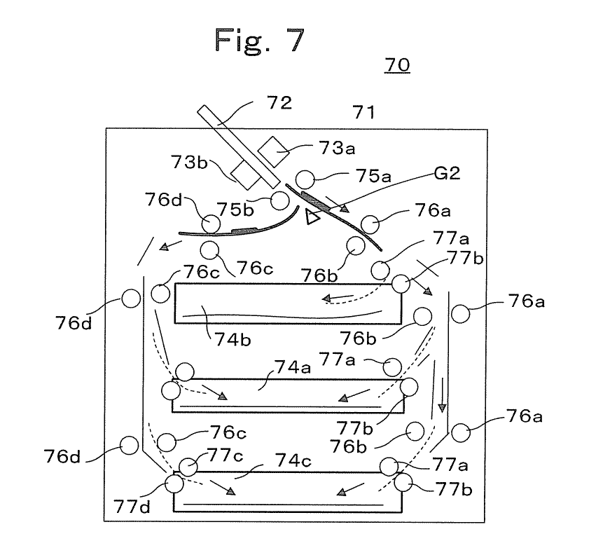

FIG. 7 shows the configuration of this embodiment. The reference numerals and symbols 70 to 77b in a document sorting apparatus 70 according to this embodiment represent similar units to those denoted by the reference numerals and symbols 10 to 17b in the apparatus according to the first embodiment shown in FIG. 1. However, in this embodiment, a reuse sheet cassette 74a is set in the second stage of an apparatus body 71, and a disposal sheet cassette 74b is set in the first stage. This document sorting apparatus 70 roughly includes the apparatus body 71, a sheet insertion tray 72, print detectors 73a and 73b which detect the presence or absence of a print on the face side and the back side of a sheet P, respectively, inserted from the sheet insertion tray 72, the reuse sheet cassette 74a which houses sheets printed on one side only, the disposal sheet cassette 74b which houses sheets printed on both sides, and a confidential sheet cassette 74c which houses sheets detected as confidential documents.

In this embodiment, a carrying path formed by a pair of carrying rollers 76c and 76d is formed as well as a carrying path formed by a pair of carrying rollers 76a and 76b. The reuse sheet cassette 74a and the confidential sheet cassette 74c can house sheets not only from the right in FIG. 7 but also from the left by housing rollers 77c and 77d.

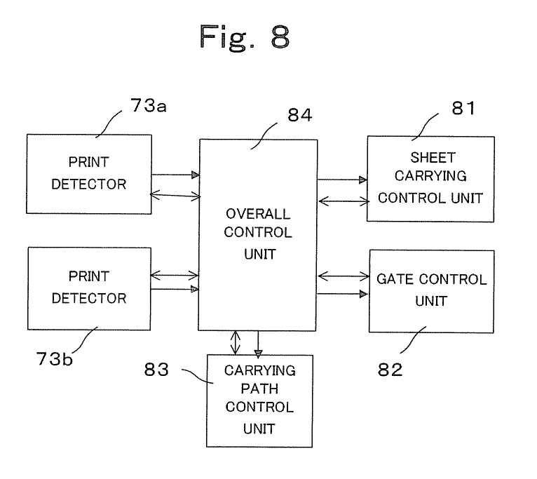

The print detectors 73a and 73b are similar to those shown in FIG. 2. The direction in which a sheet is carried is controlled by a gate G2 in accordance with the print-detected side of the sheet, and a carrying path is thus selected. FIG. 8 shows the electrical control configuration according to this embodiment.

In this case, a carrying path control unit 83 is provided instead of the reverse roller control unit 23. This carrying path control unit 83 is a circuit to control whether to send the sheet to the carrying path formed by the carrying rollers 76a and 76b or to send the sheet to the carrying path formed by the carrying rollers 76c and 76d. Other parts of the configuration, that is, a sheet carrying control unit 81, a gate control unit 82 and an overall control unit 84 are similar to those shown in FIG. 5.

As the print detectors 73a and 73b, print detectors having the same configuration as the print detectors 13a and 13b shown in FIG. 5 may be used.

A sheet P having a print detected on its face side by the print detector 73a is carried by the carrying rollers 76a and 76b and is housed in the reuse sheet cassette 74a by housing rollers 77a and 77b from the right.

A sheet P having a print detected on its back side by the print detector 73b is carried by the carrying rollers 76c and 76d and is housed in the reuse sheet cassette 74a by the housing rollers 77c and 77d from the left.

If a sheet P having a confidentiality indication but has a confidentiality level equal to or lower than a predetermined confidentiality level is inserted from the sheet insertion tray 72, since the degree of confidentiality is low, the sheet printed on one side is housed in the reuse sheet cassette 74a.

If a sheet P having an indication of a confidentiality level higher than a setting level is printed on one side only, switching is carried out as to whether to carry the sheet via the carrying path formed by the carrying rollers 76a and 76b or to carry the sheet via the carrying path formed by the carrying rollers 76c and 76d. This carrying path switching control is carried out by the carrying path control unit 83.

In the second embodiment, sheets which are printed on one side only and have a high degree of confidentiality can be housed in the confidential sheet cassette 74c with their printed sides aligned, for example, facing downward.

In the second embodiment, for sheets printed on one side only, the carrying paths are changed and the unused sides thus aligned. Therefore, though two carrying paths need to be formed, there is an advantage that a so-called switchback mechanism to return sheets at a halfway part of the carrying process is not required.

This embodiment also has an advantage that the printed sides of sheets which have a higher confidentiality level than the setting level and are printed on one side only can be aligned. Therefore, there is an advantage that confidential sheets housed in the confidential sheet cassette, particularly, confidential sheets printed on one side only, can be taken out and read easily.

### Third Embodiment

In the document sorting apparatuses according to the first and second embodiments, sheets which are unused on one side are housed in the reuse sheet cassette, with their unused sides aligned.

However, it is also possible to provide a reuse sheet cassette which houses sheets with the unused sides facing upward, and a reuse sheet cassette which houses sheets with the unused sides facing downward. By doing so, it is no longer necessary to provide a reverse mechanism or switch carrying paths in order to align the unused sides.

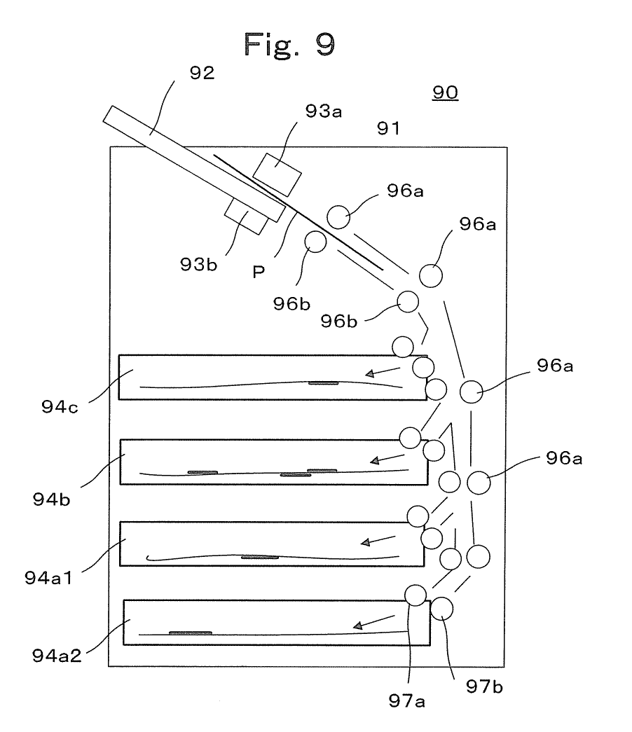

FIG. 9 shows such a configuration according to a third embodiment. A document sorting apparatus 90 shown in FIG. 9 has an apparatus body 91, a sheet insertion tray 92 in which a sheet P is inserted, print detectors 93a and 93b which detect the presence or absence of a print on the face side and the back side of the sheet inserted in the sheet insertion tray, a reuse sheet cassette 94a1 which houses reuse sheets with the upper sides unused, a reuse sheet cassette 94a2 which houses sheets with the lower sides unused, a disposal sheet cassette 94b which houses sheets printed on both sides, a confidential sheet cassette 94c which houses sheets having a higher confidentiality level than a setting level, plural pairs of carrying rollers 96a and 96b which carry sheets to these cassettes, and a pair of housing rollers 97a and 97b to house sheets in each cassette.

Although not shown, the print detectors 93a and 93b in this embodiment have the configuration as shown in FIG. 2. That is, lights from light sources are cast on the sheet P. Reflected lights are received by optical sensors and each of them is converted to an electrical signal. Based on the electrical signal, it is detected whether light-cast side of the sheet P is printed or not. After that, it is detected whether there is an indication of a confidentiality level as a confidential document. If there is an indication of a confidentiality level, it is detected whether the confidentiality indication level is higher than a preset setting level.

A confidential document having an indication of a higher level than the setting level is housed in the confidential sheet cassette 94c. A sheet P which has no indication of confidentiality level or has an indication of a lower confidentiality level than the setting level, if any, and has a print detected by both the print detectors 93a and 93b, is housed in the disposal sheet cassette 94b because the sheet is printed on both sides.

Meanwhile, a sheet P which has no indication of confidentiality level or has a lower confidentiality level than the setting level, if any, and has its lower side used and upper side unused, is housed in the reuses sheet cassette 94a1. A sheet P which has no indication of confidentiality level or has a lower confidentiality level than the setting level, if any, and has its upper side used and lower side unused, is housed in the reuses sheet cassette 94a2.

In this manner, reuse sheets with the upper sides unused are housed in the reuse sheet cassette 94a1 and reuse sheets with the lower sides unused are housed in the reuse sheet cassette 94a2.

According to this embodiment, while two reuse sheet cassettes are required, it is not necessary to provide a mechanism to reverse sheets at a halfway part of the carrying process or to change the paths. Therefore, there is an advantage that the document sorting apparatus can be reduced in size. This embodiment also has an advantage that confidentiality levels can be set flexibly and easily.

### Fourth Embodiment

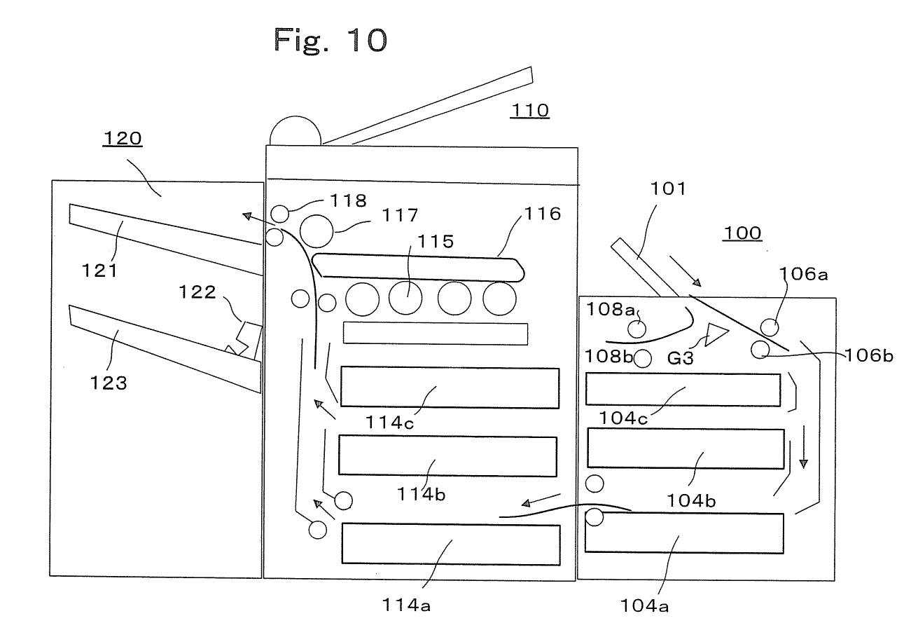

In the first, second and third embodiments, the document sorting apparatus is described as an independent apparatus. However, the document sorting apparatus can also be connected to an image forming apparatus. A fourth embodiment of the invention in such a configuration will now be described. FIG. 10 shows the overall configuration of a system including a document sorting apparatus, an image forming apparatus and a finisher apparatus according to this embodiment.

A document sorting apparatus 100 has a sheet insertion tray 101 provided on the top, a reuse sheet cassette 104a which houses sheets P unused on one sides, a disposal sheet cassette 104b which houses sheets printed on both sides, a confidential sheet cassette 104c which houses sheets having a higher confidentiality level than a setting level, carrying rollers 106a and 106b which carry each sheet, reverse rollers 108a and 108b to return sheets, for example, in a switchback-like manner in order to align the unused sides, and so on.

This document sorting apparatus 100 is similar to the first embodiment shown in FIG. 1 except for the following point. The reuse sheet cassette 104a on the lowermost stage in the document sorting apparatus 100 can supply sheets to a reuse sheet cassette 114a provided on the lowermost stage in an image forming apparatus 110, which will be described hereinafter. For example, if a reuse sheet supply button (not shown) provided on the top of the document sorting apparatus 100 is pressed, a sheet is supplied from the reuse sheet cassette 104a to the reuse sheet cassette 114a with the unused side facing upward.

The image forming apparatus 110 has, for example, the reuse sheet cassette 114a provided on the lowermost stage, plural sheet cassettes 114b and 114c provided above the cassette 114a, a mechanism to form an electrostatic latent image on four photoconductive drums 115, a transfer belt 116 to develop the latent image and transfer the developed image to a sheet P by superimposition, a fixing unit 117 which fixes the transferred image, a discharge roller mechanism 118, and the like.

The sheet P to which an image is fixed, that is, printed, is put into a finisher apparatus 120 installed near the image forming apparatus. The sheet P is then directly discharged to a discharge tray 121. Alternatively, after plural sheets are aligned and finishing such as stapling by a stapler 122 is carried out, the sheets are discharged onto a discharge tray 123.

In the fourth embodiment, the document sorting apparatus is provided as an option for the image forming apparatus.

According to this embodiment, the reuse sheet housed in the reuse sheet cassette 104a in the document sorting apparatus 100 is automatically housed into the cassette in the image forming apparatus by the pressing of a button or the like. Therefore, there is an advantage that the operator need not take out the reuse sheet from the reuse sheet cassette in the document sorting apparatus and supply the reuse sheet to the cassette in the image forming apparatus.

Also in this embodiment, it is possible to reuse a sheet having a lower confidentiality level than the setting level and having an unused side. Moreover, since the confidentiality setting level can be set from outside, it is possible to easily and flexibly prevent the reuse of a confidential document having a predetermined confidentiality level.

In each of the above embodiments, if the confidentiality level is higher than the setting level, the sheet is housed in the confidential sheet cassette as a confidential sheet. However, it is also possible to house the sheet in the confidential sheet cassette if the confidentiality level is equal to or higher than the setting level.

In each of the above embodiments, sheets are housed in the cassettes. However, the units to house sheets in the invention are not limited to cassettes and sheet housing units can be generally used.

While certain embodiments have been described, these embodiments have been presented by way of example only, and are not intended to limit the scope of the inventions. Indeed, the novel methods and systems described herein may be embodied in a variety of other forms: furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A document sorting apparatus comprising:
two print detection units which are provided facing both sides of a sheet, respectively, and detect presence or absence of a print on each side and presence or absence of an indication of a confidentiality level;
a confidential sheet housing unit which houses the sheet when a confidentiality indication level detected at least on one side is higher than a preset setting level; and
a reuse sheet housing unit which houses the sheet when a print on the sheet is detected only by one of the two print detection units and there is no indication of the confidentiality indication level.

2. The apparatus of claim 1, wherein the reuse sheet housing unit further houses the sheet when a print on the sheet is detected only by one of the two print detection units and the confidentiality indication level is lower than the setting level.

3. The apparatus of claim 2, wherein the setting level can be changed.

4. The apparatus of claim 3, wherein when a print is detected only by one of the two print detection units, the sheet is housed in the reuse sheet housing unit with the unused side of the sheet aligned with an upper side or a lower side.

5. The apparatus of claim 4, further comprising a sheet reverse mechanism which reverses the sides of the sheet in accordance with the side where the print is detected by the two print detection units.

6. The apparatus of claim 4, further comprising a carrying path control unit which reverses the sides of the sheet by changing a carrying path of the sheet in accordance with the side where the print is detected by the two print detection units.

7. The apparatus of claim 3, wherein the reuse sheet housing unit has a first reuse sheet housing unit which houses the sheet with its unused side facing upward, and a second reuse sheet housing unit which houses the sheet with its unused side facing downward.

8. The apparatus of claim 3, wherein when confidentiality indication levels are detected by both of the two print detection units and the confidentiality indication levels are different, a confidentiality level comparison unit compares the higher confidentiality indication level with the setting level.

9. A document sorting apparatus comprising:
first and second print detection units which detect whether first and second sides of a sheet that is printed at least on one side are printed or not, respectively, and detect whether a confidentiality level indicating a degree of confidentiality is indicated or not;
a confidentiality level comparison unit which, when it is detected by one of the first and second print detection units that the confidentiality level is indicated on the sheet, compares a confidentiality indication level with a preset setting level;
a confidential sheet housing unit which houses the sheet when it is determined by the confidentiality level comparison unit that the confidentiality indication level is higher than the setting level; and
a reuse sheet housing unit which houses the sheet when a print on the sheet is detected only by one of the first and second print detection units and there is no indication of the confidentiality indication level on the side where the print is detected.

10. The apparatus of claim 9, wherein the reuse sheet housing unit houses the sheet when a print on the sheet is detected only by one of the first and second print detection units and it is determined by the confidentiality level comparison unit that the confidentiality indication level is lower than the setting level.

11. The apparatus of claim 10, wherein the setting level can be changed.

12. The apparatus of claim 11, further comprising a disposal sheet hosing unit which houses the sheet when the print on the sheet is detected by the first print detection unit and the second print detection unit and the confidentiality indication level is not detected by either one of the print detection units.

13. The apparatus of claim 12, wherein when a print is detected only by one of the first and second print detection units, the sheet is housed in the reuse sheet housing unit with the unused side of the sheet aligned with an upper side or a lower side.

14. The apparatus of claim 13, further comprising a sheet reverse mechanism which reverses the sides of the sheet in accordance with the side where the print is detected by the first and second print detection units.

15. The apparatus of claim 13, further comprising a carrying path control unit which reverses the sides of the sheet by changing a carrying path of the sheet in accordance with the side where the print is detected by the first and second print detection units.

16. The apparatus of claim 13, wherein the reuse sheet housing unit has a first reuse sheet housing unit which houses the sheet with its unused side facing upward, and a second reuse sheet housing unit which houses the sheet with its unused side facing downward.

17. The apparatus of claim 12, wherein when the confidentiality indication levels are detected by both of the first print detection unit and the second print detection unit and the confidentiality indication levels are different, the confidentiality level comparison unit compares the higher confidentiality indication level with the setting level.

18. The apparatus of claim 12, wherein the sheet housed in the reuse sheet housing unit can be automatically supplied to a reuse sheet housing unit in an image forming apparatus which forms a latent image and then prints the image that is made visible.

19. A document sorting method comprising:
by two print detection units which are provided facing both sides of a sheet, respectively, detecting presence or absence of a print on each side of the sheet and presence or absence of an indication of a confidentiality level;
housing the sheet in a confidential sheet housing unit when a confidentiality indication level detected at least on one side is higher than a preset setting level; and
housing the sheet in a reuse sheet housing unit when a print on the sheet is detected only by one of the two print detection units and there is no indication of the confidentiality indication level.

20. The method of claim 19, wherein when a print on the sheet is detected only by one of the two print detection units and the confidentiality indication level is lower than the setting level, the sheet is housed in the reuse sheet housing unit.
